(19) United States
(12) Patent Application Publication
(10) Pub. No.: US 2012/0103114 A1
(43) Pub. Date: May 3, 2012

(54) MULTI-CHANNEL ROTATIONAL CONTROL DEVICE WITH CLUSTER LINKAGE

(75) Inventors: William Ross McLennan, Perkiomenville, PA (US); Michael J. Cross, Souderton, PA (US)

(73) Assignee: TRANSICOIL LLC, Collegeville, PA (US)

(21) Appl. No.: 13/283,728

(22) Filed: Oct. 28, 2011

Related U.S. Application Data
(60) Provisional application No. 61/408,348, filed on Oct. 29, 2010.

(51) Int. Cl. F16H 35/18; B23P 11/00

(52) U.S. Cl. 74/10.45; 29/428

(57) ABSTRACT

A cluster linkage parallel multi-channel rotational control device comprising two or more single channel rotational control devices operatively connected by a cluster linkage assembly to a central shaft. The central shaft is attached to a control input, for example, an aircraft control input. A housing surrounds the central shaft. Each single channel rotational control device is contained within and fixed to the housing. A bearing set supports the central shaft within the housing.

### CROSS REFERENCE TO RELATED APPLICATIONS

This application claims benefit of U.S. Provisional Application No. 61/408,348 filed Oct. 29, 2010.

### FIELD OF THE INVENTION

This invention relates generally to rotational control devices and in particular, to a rotary variable differential transformer.

### BACKGROUND OF THE INVENTION

A rotational control device is used to indicate the position of a rotary shaft. More particularly, a rotary variable differential transformer (“RVDT”) is used to measure rotational angles to accurately indicate the position of a rotary shaft. The RVDT provides an electronic signal which changes with the shaft rotational position.

RVDT's are relatively low in cost, sturdy, have a low signal to noise ratio and a low output impedance. They offer negligible hysteresis and an angle resolution that is limited only by the resolution of the amplifiers and voltage meters used to process the output signal. An RVDT will not sustain permanent damage if measurements exceed the design range.

Basic RVDT construction and operation is provided by rotating an iron-core bearing supported within a housed stator assembly. The housing is passivated stainless steel. The stator consists of a primary excitation coil and a pair of secondary output coils. A fixed alternating current excitation is applied to the primary stator coil that is electromagnetically coupled to the secondary coils. This coupling is proportional to the angle of the input shaft. The output pair is structured so that one coil is in-phase with the excitation coil, and the second is 180 degrees out-of-phase with the excitation coil.

When the rotor is in a position that directs the available flux equally in both the in-phase and out-of-phase coils, the output voltages cancel and result in a zero value signal. This is referred to as the electrical zero position. When the rotor shaft is displaced from electrical zero, the resulting output signals have a magnitude and phase relationship proportional to the direction of rotation. Because RVDT's perform essentially like a transformer, excitation voltages changes will cause directly proportional changes to the output, referred to as the transformation ratio. The voltage out to excitation voltage ratio will remain constant. Most RVDT signal conditioning systems measure signal as a function of the transformation ratio.

Where system redundancy and increased reliability is advisable, for example, aircraft applications such as accurately indicating aircraft control surface position to a cockpit crew, multi-channel RVDTs are utilized. In one form, separate channels are placed in tandem inside a common housing. A common shaft mounts separate rotor stacks each producing an output voltage proportional to their angular displacement.

In a second form, depicted in FIG. PA-1, separate channels are mounted in parallel, allowing a greater number of independent channels in a shorter housing. Although the diameter of the total package size will increase, this design allows for easy replacement of a channel because the multi-channel unit is comprised of separate single channel RVDTs. A single anti-backlash gear connects each channel to the input shaft.

Backlash, also referred to as lash or play, is the clearance between mating components. In a pair of gears backlash is the amount of clearance between mated gear teeth. This space results in lost motion when movement is reversed and contact is reestablished. For many applications, such as when used in an aircraft, backlash is undesirable. It is minimized through the use of ball screws in place of leadscrews, and by using preloaded bearings. A preloaded bearing uses a spring or other compressive force to maintain bearing surfaces in contact despite reversal of direction.

Accordingly, there is still a continuing need for improved multi-channel rotational control device system designs. The present invention fulfills this need and further provides related advantages.

### BRIEF SUMMARY OF THE INVENTION

The present invention replaces gearing used in a parallel multi-channel rotational control device with linkage utilizing levers. This change results in a lighter, more reliable and more accurate device when using the same or equivalent manufacturing technologies and tolerances.

Embodiments of the present invention include anti-backlash within a linking arm that connects the levers. Components can be easily added to provide break away in the case of jamming of the rotational control device. In one preferred embodiment springs are added to the linkage to provide return to center or electrical zero position and stops can be added to prevent over rotation.

Other features and advantages of the present invention will be apparent from the following more detailed description of the preferred embodiments, taken in conjunction with the accompanying drawings which illustrate, by way of example, the principles of the invention.

### BRIEF DESCRIPTION OF THE DRAWINGS

The accompanying drawings are included to provide a further understanding of the present invention. These drawings are incorporated in and constitute a part of this specification, illustrate one or more embodiments of the present invention, and together with the description, serve to explain the principles of the present invention.

FIG. PA-1 is a perspective view of a known multi-channel RVDT utilizing gears.

FIG. 1 is a front view of one embodiment of the present disclosure.

FIG. 2 is a side view of one embodiment of the present disclosure.

FIG. 3 is a perspective view of one embodiment of the present disclosure.

FIG. 4 is an exploded perspective view of one embodiment of the present disclosure.

FIG. 5 is a front view of an alternate embodiment of an anti-backlash spring arrangement.

FIG. 6 is a perspective view of the alternate embodiment of the anti-backlash spring arrangement.

Other features and advantages of the present invention will be apparent from the following more detailed description of the preferred embodiments, taken in conjunction with the accompanying drawings which illustrate, by way of example, the principles of the invention.

### DETAILED DESCRIPTION OF THE INVENTION

As required, detailed embodiments of the present invention are disclosed; however, it is to be understood that the disclosed embodiments are merely exemplary of the invention that may be embodied in various forms. The figures are not necessary to scale, and some features may be exaggerated to show details of particular components. Therefore, specific structural and functional details disclosed are not to be interpreted as limiting, but merely as a basis for the claims and as a representative basis for teaching one skilled in the art to variously employ the present invention. Where possible, like reference numerals have been used to refer to like parts in the several alternative embodiments of the present invention described herein.

FIG. PA-1 displays known multi-channel RVDT technology using gears, for example, as taught in U.S. Pat. No. 7,353,608. A solid main gear PA-60 is coupled to the main shaft. A series of anti-backlash gears PA-65 or secondary gears are rigidly coupled to each RVDT shaft and are positioned to mesh with the main gear PA-60, thereby providing RVDT redundancy.

Unlike known technology, the present invention does not use inter-meshing gears to provide rotational control device redundancy in a multi-channel rotational control device. Rather, cluster linkage is used to provide the redundancy.

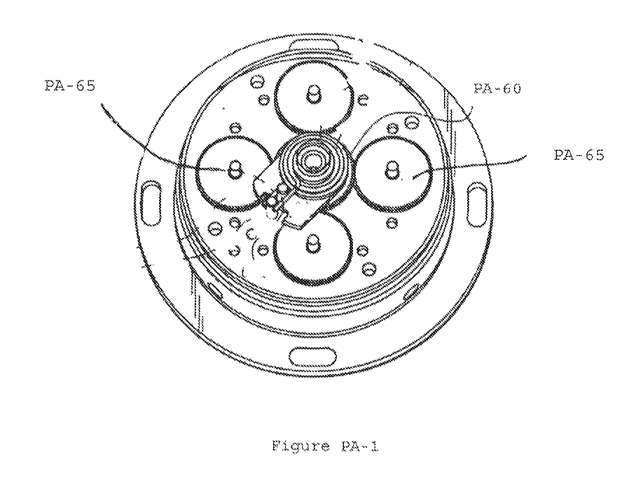

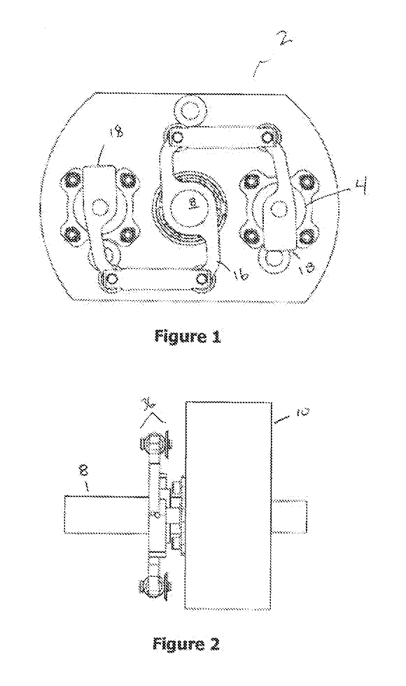

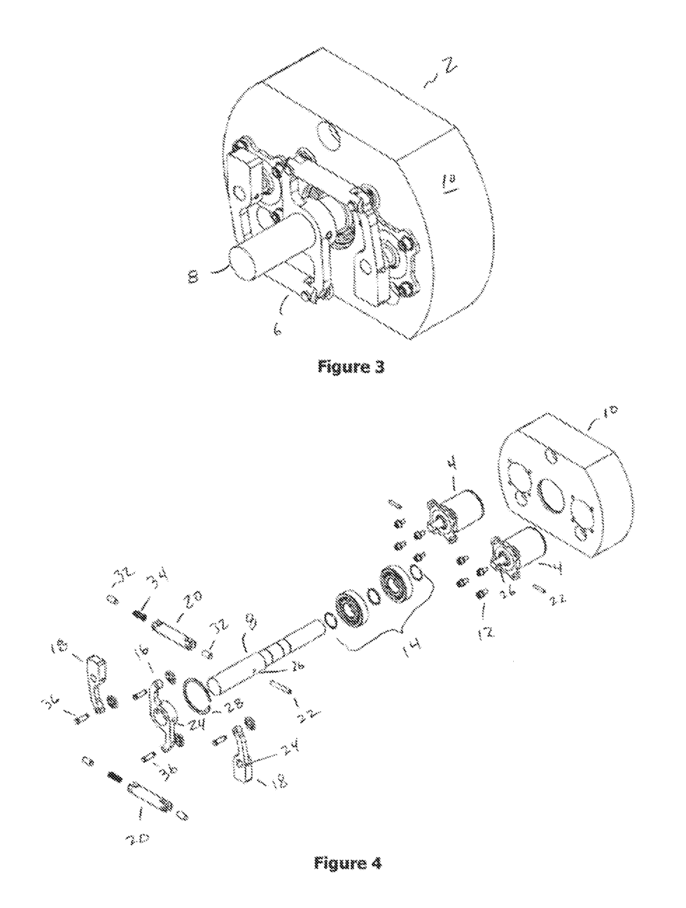

Turning now to FIGS. 1-4, in a preferred embodiment, a cluster linkage multi-channel rotational control device, for example, a RVDT 2 comprises two or more single channel RVDTs 4 operatively connected by cluster linkage assembly 6 to a central shaft 8. The central shaft 6 is operatively connected to a control input, for example, an aircraft control input (not shown). A housing 10 surrounds the central shaft 8. Each single channel RVDTs 4 is contained within and fixed to the housing 10 using, for example, fasteners 12. A bearing set 14 supports the central shaft 8 within housing 10. Bearing set 14 is positionally maintained using, for example, C ring 28.

Cluster linkage assembly 6 operatively connects each single channel RVDT 4 to the central shaft 8 employing two lever arms, one affixed to the single channel RVDT 4 and one to the central input shaft 8, with a central bar linking the two lever arms. For each single channel RVDT 4, cluster linkage assembly 6 comprises a shaft lever arm 16, RVDT lever arm 18 and a central bar 20.

The shaft lever arm 16 is attached to the central shaft 8, for example, using pin 22, lever arm orifice 24 and shaft pin orifice 26. In this manner a single linkage hub 38 on the central shaft 8 comprising one or more shaft lever arms 24 operatively connects the linkage arms for all single channel RVDTs 4. Pins 30 on each end of the central bar 20 are used in a clevis type arrangement linking it to the shaft lever arm 16 and RVDT lever arm 18. Each RVDT lever arm 18 is attached to its respective single channel RVDT 4 by, for example, pin 22, lever arm orifice 24 and shaft pin orifice 26.

The central bar 20 has a central thru hole making it hollow from end to end. Two plugs 32 each translationally movable are positioned inside the ends of the hollow in the central bar 20 and an expansion element, for example, a spring 34 is located between the plugs 32. When the central bar 20, plugs 32 and spring 34 are assembled between shaft lever arm 16 and RVDT lever arm 18 using, for example, a clevis pin arrangement 36, each plug 32 is situated against a clevis pin 36 so as to use the expansive spring force to exert a separating force between the two clevis pins 36 at each end of the central bar 20.

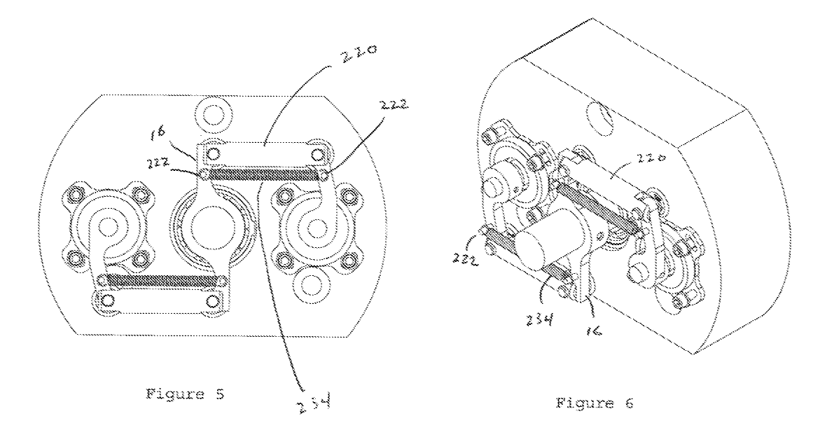

In an alternate embodiment, shown in FIGS. 5 and 6, central bar 220 may or may not be hollow. Rather than a spring and plugs arrangement, a compression element, for example, a spring 234 is fixed to shaft lever arm 16 and RVDT lever arm 18 using, for example, a pin 222 on each arm. In this manner, the spring 234 exerts a contracting force between the shaft lever arm 16 and RVDT lever arm 18. Although the figures show the spring 234 fixed outside the central bar 220, it should be apparent that the spring 222 can be just a easily placed inside a hollow central bar 220.

This separating/contracting force acts to hold the shaft lever arm 16 and RVDT lever arm 18 in a constant state of forced separation/contraction, thereby removing any hysteresis between the two arms 16, 18 and the central bar 20/220 during rotational movement and providing anti-backlash.

In this manner accurate redundant central shaft rotational positional information is provided.

Although the present invention has been described in connection with specific examples and embodiments, those skilled in the art will recognize that the present invention is capable of other variations and modifications within its scope. For example, while the exemplar depicts two single channel RVDTs within the housing, the invention is not limited to only two. Furthermore, the invention is applicable to other rotational control devices such as rotary variable transformers (RVT) and resolvers. These examples and embodiments are intended as typical of, rather than in any way limiting on, the scope of the present invention as presented in the appended claims.

What is claimed is:

1. A multi-channel rotational control device comprising two or more single channel rotational control devices fixed to a housing, each single channel rotational control device operatively connected by a cluster linkage assembly to a central shaft supported within the housing by a bearing set.

2. The multi-channel rotational control device of claim 1 further comprising anti-backlash.

3. The multi-channel rotational control device of claim 2 wherein the anti-backlash comprises an expansion element exerting a separating force upon the cluster linkage.

4. The multi-channel rotational control device of claim 2 wherein the anti-backlash comprises a compression element exerting a contracting force upon the cluster linkage.

5. The multi-channel rotational control device of claim 1 wherein the rotational control device is a RVDT.

6. A multi-channel rotational control device comprising two or more single channel rotational control devices fixed to a housing, each single channel rotational control device operatively connected by a cluster linkage assembly to a central shaft supported within the housing by a bearing set;
wherein the cluster linkage assembly comprises
a first lever arm affixed to a single channel rotational control device;
a second lever arm affixed to the central shaft; and
a central bar operatively connecting the first and second lever arms.

7. The multi-channel rotational control device of claim 6 wherein a single linkage hub on the central shaft operatively connects to all first lever arms.

8. The multi-channel rotational control device of claim 6 wherein the central bar provides anti-backlash.

9. The multi-channel rotational control device of claim 8 wherein the anti-backlash comprises an expansion element exerting a separating force between the first and second lever arms.

10. The multi-channel rotational control device of claim 8 wherein the anti-backlash comprises a hollow central bar, a first and second plug each translationally movably positioned within the hollow central bar, and an expansion element positioned between the first and second plug such that the expansion element causes the first and second plugs to exert a separating force between the first and second lever arms.

11. The multi-channel rotational control device of claim 10 wherein the expansion element is a spring.

12. The multi-channel rotational control device of claim 10 wherein the rotational control device is a RVDT.

13. The multi-channel rotational control device of claim 8 wherein the anti-backlash comprises a compression element exerting a compressive force between the first and second lever arms.

14. The multi-channel rotational control device of claim 6 further comprising anti-backlash wherein the anti-backlash comprises a compression element fixed to the first and second lever arms.

15. The multi-channel rotational control device of claim 14 wherein the compression element is a spring.

16. The multi-channel rotational control device of claim 14 wherein the rotational control device is a RVDT.

17. A method for providing redundant rotational control device input comprising the steps of:
a. fixing two or more single channel rotational control devices to a housing; and
b. operatively connecting each single channel rotational control device by a cluster linkage assembly to a central shaft supported within the housing by a bearing set, the central shaft for operatively communicating with a control input.

18. The method of claim 17 wherein the cluster linkage comprises anti-backlash.

19. The method of claim 18 wherein the anti-backlash comprises an expansion element exerting a separating force upon the cluster linkage.

20. The method of claim 18 wherein the anti-backlash comprises an compression element exerting a compressive force upon the cluster linkage.

21. A method for providing redundant rotational control device input comprising the steps of:
a. fixing two or more single channel rotational control devices to a housing; and
b. operatively connecting each single channel rotational control device by a cluster linkage assembly to a central shaft supported within the housing by a bearing set, the central shaft for operatively communicating with a control input;
wherein the cluster linkage assembly comprises
a first lever arm affixed to a single channel rotational control device;
a second lever arm affixed to the central shaft; and
a central bar operatively connecting the first and second lever arms.

22. The method of claim 21 wherein a single linkage hub on the central shaft operatively connects to all first lever arms.

23. The method of claim 21 wherein the central bar provides anti-backlash.

24. The method of claim 23 wherein the anti-backlash comprises an expansion element exerting a separating force between the first and second lever arms.

25. The method of claim 23 wherein the anti-backlash comprises a hollow central bar, a first and second plug each translationally movably positioned within the hollow central bar, and an expansion element positioned between the first and second plug such that the expansion element causes the first and second plugs to exert a separating force between the first and second lever arms.

26. The method of claim 25 wherein the expansion element is a spring.

27. The method of claim 23 wherein the anti-backlash comprises a compression element exerting a compressive force between the first and second lever arms.

28. The method of claim 21 further comprising anti-backlash wherein the anti-backlash comprises a compression element fixed to the first and second lever arms.

29. The method of claim 28 wherein the compression element is a spring.
